(19) United States
(12) Patent Application Publication
(10) Pub. No.: US 2018/0184066 A1
(43) Pub. Date: Jun. 28, 2018

(54) LIGHT FIELD RETARGETING FOR MULTI-PANEL DISPLAY

(71) Applicant: Intel Corporation, Santa Clara, CA (US)

(72) Inventors: Basel Salahieh, Santa Clara, CA (US); Seth E. Hunter, Santa Clara, CA (US); Yi Wu, San Jose, CA (US); Oscar Nestares, San Jose, CA (US)

(73) Assignee: Intel Corporation, Santa Clara, CA (US)

(21) Appl. No.: 15/391,920

(22) Filed: Dec. 28, 2016

(51) Int. Cl. H04N 13/00; H04N 13/02; H04N 13/04; G06F 3/14; G06F 3/147

(52) U.S. Cl. CPC H04N 13/0022; H04N 13/0271; H04N 13/0459; H04N 13/0422; H04N 13/0025; H04N 13/0497; H04N 2213/001; H04N 13/0011; H04N 13/0409; H04N 13/0425; G06F 3/1423; G06F 3/147; H04N 13/0484

(57) ABSTRACT

In one example, a method for displaying three dimensional light field data can include generating a three dimensional image. The method can also include generating a plurality of disparity maps based on light field data and converting the disparity maps to depth maps. Additionally, the method can include generating a plurality of data slices. The plurality of slices per viewing angle can be shifted and merged together resulting in enhanced parallax of light field data. Furthermore, the method can include filling at least one unrendered region of the merged plurality of data slices with color values based on an interpolation of pixels proximate the at least one unrendered region and displaying modified a three dimensional image based on the merged plurality of data slices with the at least one filled region.

### TECHNICAL FIELD

This disclosure relates generally to a three dimensional display and specifically, but not exclusively, to generating a dynamic three dimensional image by displaying light fields on a multi-panel display.

### BACKGROUND

Light fields are a collection of light rays emanating from real-world scenes at various directions. Light fields can enable a computing device to calculate a depth of captured light field data and provide parallax cues on a three dimensional display. In some examples, light fields can be captured with plenoptic cameras that include a micro-lens array in front of an image sensor to preserve the directional component of light rays.

### BRIEF DESCRIPTION OF THE DRAWINGS

The following detailed description may be better understood by referencing the accompanying drawings, which contain specific examples of numerous features of the disclosed subject matter.

FIG. 1 illustrates a block diagram of a three dimensional display using multiple display panels and a projector;

FIG. 2 is a block diagram of a computing device electronically coupled to a three dimensional display using multiple display panels and a projector;

FIGS. 3A and 3B illustrate a process flow diagram for retargeting light fields to a three dimensional display with multiple display panels and a projector;

FIG. 4 is an example of three dimensional content;

FIG. 5 is an example diagram depicting alignment and calibration of a three dimensional display using multiple display panels and a projector; and

FIG. 6 is an example of a tangible, non-transitory computer-readable medium for generating a three dimensional image to be displayed by a three dimensional display with multiple display panels and a projector.

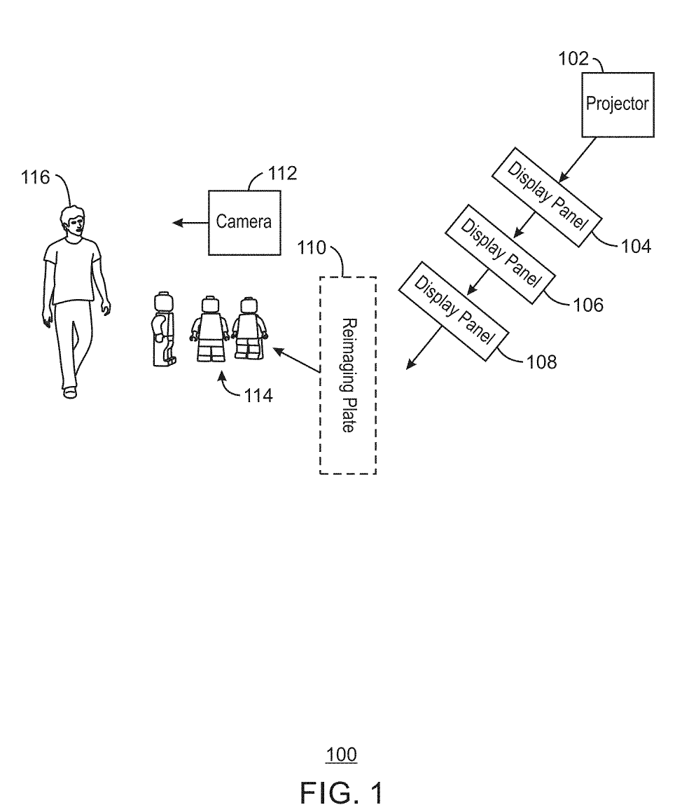

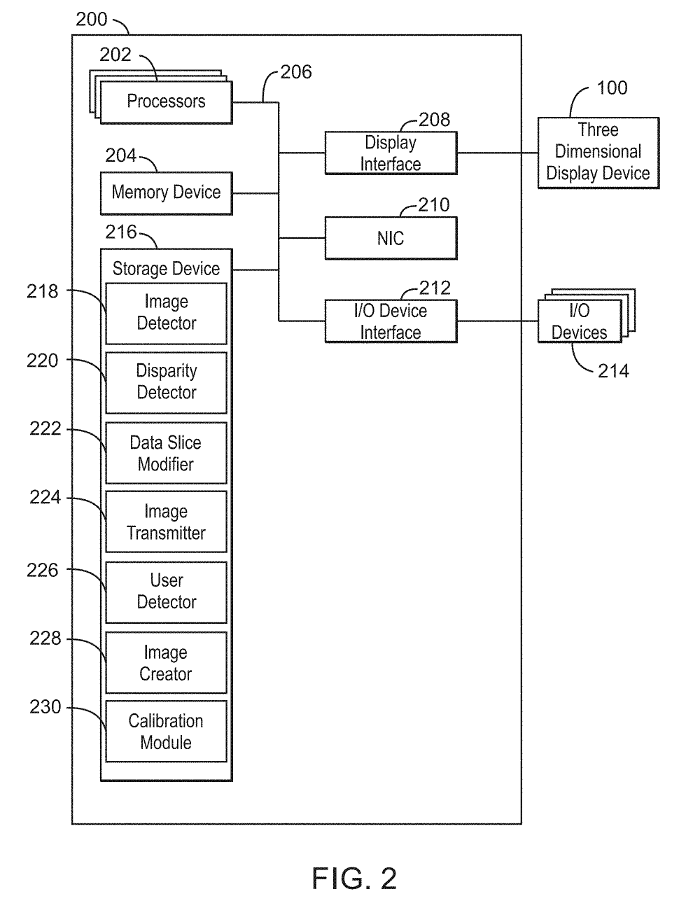

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The techniques described herein enable the generation and projection of a three dimensional image based on a light field. A light field can include a collection of light rays emanating from a real-world scene at various directions, which enables calculating depth and providing parallax cues on three dimensional displays. In one example, a light field image can be captured by a plenoptic or light field camera, which can include a main lens and a micro-lens array in front of an image sensor to preserve the directional or angular component of light rays. However, the angular information captured by a plenoptic camera is limited by the aperture extent of the main lens, light loss at the edges of the micro-lens array, and a trade-off between spatial and angular resolution inherent in the design of plenoptic cameras. The resulting multi-view images have a limited baseline or range of viewing angles that are insufficient for a three dimensional display designed to support large parallax and render wide depth from different points in the viewing zone of the display.

Techniques described herein can generate three dimensional light field content of enhanced parallax that can be viewed from a wide range of angles. In some embodiments, the techniques include generating the three dimensional light field content or a three dimensional image based on separate two dimensional images to be displayed on various display panels of a three dimensional display device. The separate two dimensional images can be blended, in some examples, based on a depth of each pixel in the three dimensional image. The techniques described herein also enable modifying the parallax of the image based on a user's viewing angle of the image being displayed, filling unrendered pixels in the image resulting from parallax correction, blending the various two dimensional images across multiple display panels, and providing angular interpolation and multi-panel calibration based on tracking a user's position.

In some embodiments described herein, a system for displaying three dimensional images can include a projector, a plurality of display panels, and a processor. In some examples, the projector can project light through the plurality of display panels and a reimaging plate to display a three dimensional object. The processor may detect light field views or light field data, among others, and generate a plurality of disparity maps based on the light field views or light field data. The disparity maps, as referred to herein, can indicate a shift in a pixel that is capture by multiple sensors or arrays in a camera. For example, a light field camera that captures light field data may use a micro-lens array to detect light rays in an image from different angles.

In some embodiments, the processor can also convert the disparity maps to a plurality of depth maps, which can be quantized to any suitable number of depth levels according to a preset number of data slices. Additionally, the processor can generate a plurality of data slices corresponding to two dimensional representations of light field data with various depths based on the quantized depth maps. For example, the processor can generate any suitable number of data slices per viewing angle based on the quantized depth map corresponding to the viewing angle. Each data slice extracted from the corresponding light field data can be formed of pixels belonging to the same quantized depth plane. Furthermore, the processor can merge the plurality of data slices based on a parallax determination and fill at least one unrendered region of the merged plurality of data slices with color values based on an interpolation of pixels proximate the at least one unrendered region. Parallax determination, as referred to herein, includes detecting that a viewing angle of a user has shifted and modifying a display of an object in light field data based on the user's viewpoint, wherein data slices are shifted in at least one direction and at least one magnitude. The parallax determination can increase the range of viewing angles from which the plurality display panels are capable of displaying the three dimensional image (also referred to herein as image). For example, the processor can generate a change in parallax of background objects based on different viewing angles of the image. The processor can fill holes in the light field data resulting from a change in parallax that creates regions of the image without a color rendering. In addition, the processor can display modified light field data based on the merged plurality of data slices per viewing angle with the filled regions and a multi-panel blending technique. For example, the processor can blend the data slices based on a number of display panels to enable continuous depth perception given a limited number of display panels and project a view of the three dimensional image based on an angle between a user and the display panels. In some embodiments, the techniques described herein can also use a multi-panel calibration to align content in the three dimensional image from any number of display panels based on a user's viewing angle.

The techniques described herein can enable a three dimensional object to be viewed without stereoscopic glasses. Additionally, the techniques described herein enable off axis rendering. Off axis rendering, as referred to herein, can include rendering an image from a different angle than originally captured to enable a user to view the image from any suitable number of angles.

Reference in the specification to “one embodiment” or “an embodiment” of the disclosed subject matter means that a particular feature, structure, or characteristic described in connection with the embodiment is included in at least one embodiment of the disclosed subject matter. Thus, the phrase “in one embodiment” may appear in various places throughout the specification, but the phrase may not necessarily refer to the same embodiment.

FIG. 1 illustrates a block diagram of a three dimensional display using multiple display panels and a projector. In some embodiments, the three dimensional display device 100 can include a projector 102, and display panels 104, 106, and 108. The three dimensional display device 100 can also include a reimaging plate 110 and a camera 112.

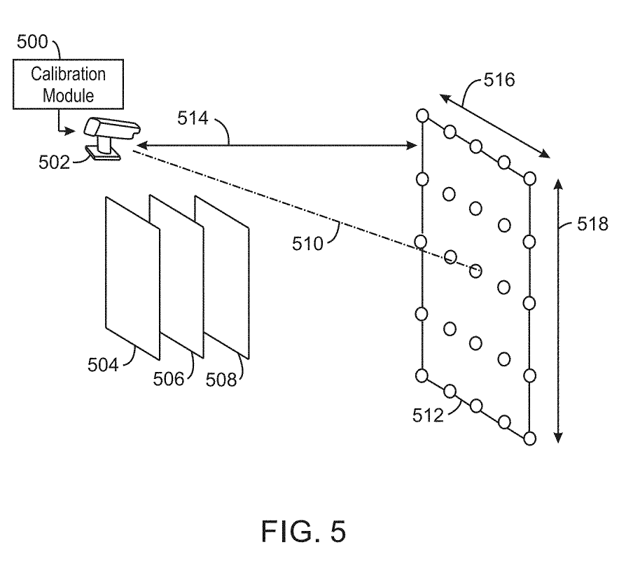

In some embodiments, the projector 102 can project modified light field data through display panels 104, 106, and 108. In some examples, the projector 102 can use light emitting diodes (LEDs), and micro-LEDs, among others, to project light through the display panels 104, 106, and 108. In some examples, each display panel 104, 106, and 108 can be a liquid crystal display, or any other suitable display, that does not include polarizers. In some embodiments, as discussed in greater detail below in relation to FIG. 5, each of the display panels 104, 106, and 108 can be rotated in relation to one another to remove any Moiré effect. In some embodiments, the reimaging plate 110 can generate a three dimensional image 114 based on the display output from the displays 104, 106, and 108. In some examples, the reimaging plate 110 can include a privacy filter to limit a field of view for individuals located proximate a user of the three dimensional display device 100 and to prevent ghosting, wherein a second unintentional image can be viewed by a user of the three dimensional display device 100. The reimaging plate 110 can be placed at any suitable angle in relation to display panel 108. For example, the reimaging plate 110 may be placed at a forty-five degree angle in relation to display panel 108 to project or render the three dimensional image 114.

In some embodiments, the camera 112 can monitor a user 116 in front of the display panels 104, 106, and 108. The camera 112 can detect if a user 116 moves to view the three dimensional image 114 from a different angle. In some embodiments, the projector 102 can project a modified three dimensional image from a different perspective based on the different angle. Accordingly, the camera 112 can enable the projector 102 to continuously modify the three dimensional image 114 as the user 116 views the three dimensional image 114 from different perspectives or angles.

It is to be understood that the block diagram of FIG. 1 is not intended to indicate that the three dimensional display device 100 is to include all of the components shown in FIG. 1. Rather, the three dimensional display device 100 can include fewer or additional components not illustrated in FIG. 1 (e.g., additional display panels, etc.). In some examples, the three dimensional display device 100 may include two or more display panels. For example, the three dimensional display device 100 may include two, three, or four liquid crystal display devices.

FIG. 2 is a block diagram of an example of a computing device electronically coupled to a three dimensional display using multiple display panels and a projector. The computing device 200 may be, for example, a mobile phone, laptop computer, desktop computer, or tablet computer, among others. The computing device 200 may include processors 202 that are adapted to execute stored instructions, as well as a memory device 204 that stores instructions that are executable by the processors 202. The processors 202 can be single core processors, multi-core processors, a computing cluster, or any number of other configurations. The memory device 204 can include random access memory, read only memory, flash memory, or any other suitable memory systems. The instructions that are executed by the processors 202 may be used to implement a method that can generate a three dimensional image using multiple display panels and a projector.

The processors 202 may also be linked through the system interconnect 206 (e.g., PCI®, PCI-Express®, NuBus, etc.) to a display interface 208 adapted to connect the computing device 200 to a three dimensional display device 100. As discussed above, the three dimensional display device 100 may include a projector, any number of display panels, any number of polarizers, and a reimaging plate. In some embodiments, the three dimensional display device 100 can be a built-in component of the computing device 200. The three dimensional display device 100 can include light emitting diodes (LEDs), and micro-LEDs, among others.

In addition, a network interface controller (also referred to herein as a NIC) 210 may be adapted to connect the computing device 200 through the system interconnect 206 to a network (not depicted). The network (not depicted) may be a cellular network, a radio network, a wide area network (WAN), a local area network (LAN), or the Internet, among others.

The processors 202 may be connected through a system interconnect 206 to an input/output (I/O) device interface 212 adapted to connect the computing device 200 to one or more I/O devices 214. The I/O devices 214 may include, for example, a keyboard and a pointing device, wherein the pointing device may include a touchpad or a touchscreen, among others. The I/O devices 214 may be built-in components of the computing device 200, or may be devices that are externally connected to the computing device 200. In some embodiments, the I/O devices 214 can include a first camera to monitor a user for a change in angle between the user's field of view and the three dimensional display device 100. The I/O devices 214 may also include a light field camera or plenoptic camera, or any other suitable camera, to detect light field images or images with pixel depth information to be displayed with the three dimensional display device 100.

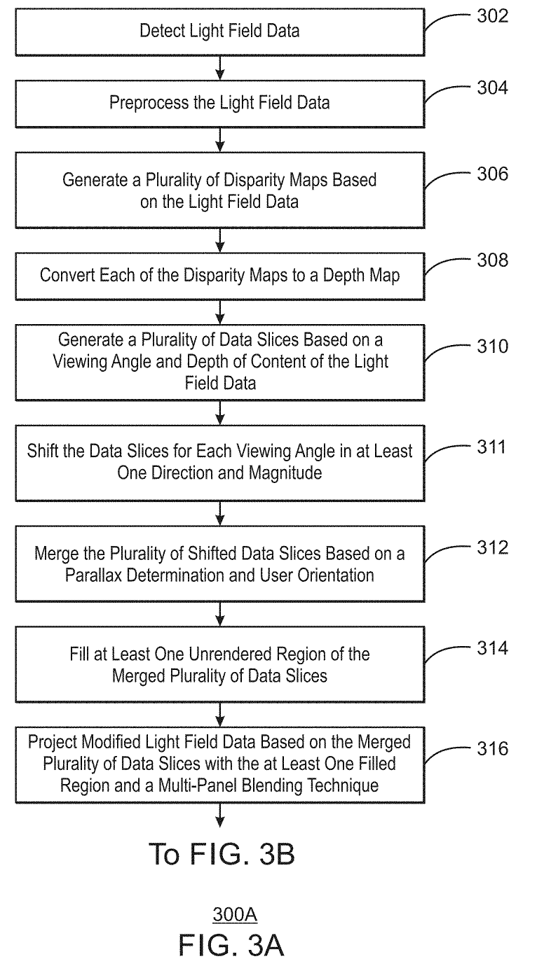

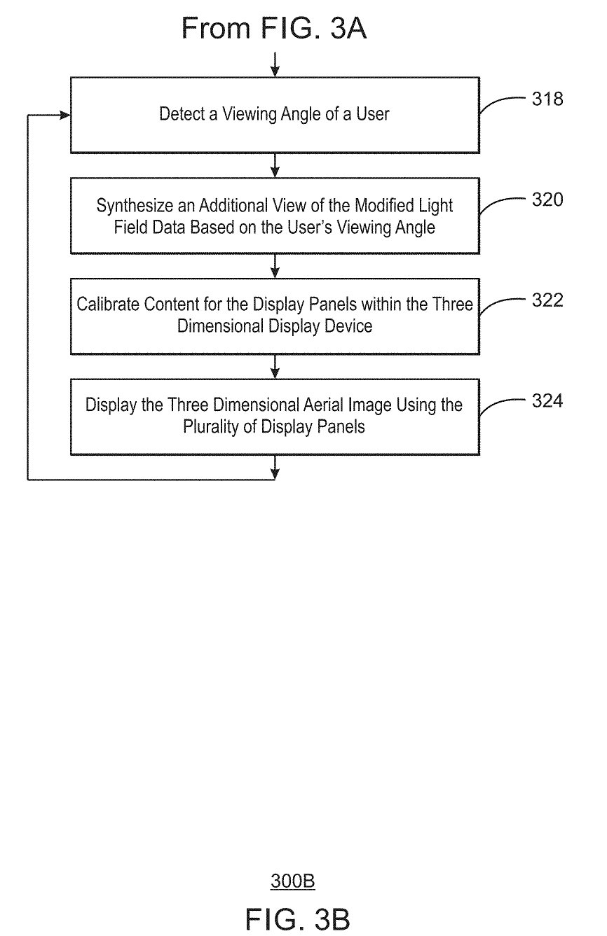

In some embodiments, the processors 202 may also be linked through the system interconnect 206 to any storage device 216 that can include a hard drive, an optical drive, a USB flash drive, an array of drives, or any combinations thereof. In some embodiments, the storage device 216 can include any suitable applications. In some embodiments, the storage device 216 can include an image detector 218, disparity detector 220, a data slice modifier 222, and an image transmitter 224, which can implement the techniques described herein. In some embodiments, the image detector 218 can detect light field data or light field views from a light field camera an array of cameras, or a computer generated light field image from rendering software. Light field data, as referred to herein, can include any number of images that include information corresponding to an intensity of light in a scene and a direction of light rays in the scene. In some examples, the disparity detector 220 can generate a plurality of disparity maps based on light field data. For example, the disparity detector 220 can compare light field data from different angles to detect a shift of each pixel. In some embodiments, the disparity detector 220 can also convert each of the disparity maps to a depth map. For example, the disparity detector 220 can detect a zero disparity plane, a baseline and a focal length of a camera that captured the image. A baseline, as discussed above, can indicate a range of viewing angles for light field data. For example, a baseline can indicate a maximum shift in viewing angle of the light field data. A zero disparity plane can indicate a depth map which does not include a shift in pixel values. Techniques for detecting the zero disparity plane, the baseline, and the focal length of a camera are discussed in greater detail below in relation to FIG. 3.

In some embodiments, a data slice modifier 222 can generate a plurality of data slices based on a viewing angle of a user and a depth of content of light field data. In some examples, the depth of the content of light field data is determined from the depth maps. As discussed above, each data slice can represent a set of pixels grouped based on a depth plane for a given viewing angle of a user. In some examples, the data slice modifier 222 can shift a plurality of data slices based on a viewing angle of a user in at least one direction and at least one magnitude to create a plurality of shifted data slices. In some embodiments, the data slice modifier 222 can also merge the plurality of shifted data slices based on a parallax determination. For example, the data slice modifier 222 can shift background objects in the light field data and occluded objects or objects in the light field data based on a viewing angle of a user. In some examples, pixels that should not be visible to a user can be modified or covered by pixels in the foreground. Techniques for parallax determination are described in greater detail below in relation to FIG. 3. In some embodiments, the data slice modifier 222 can also fill at least one unrendered region of the merged plurality of data slices with color values based on an interpolation of pixels proximate the at least one unrendered region. For example, the data slice modifier 222 can detect a shift in the data slices that has resulted in unrendered pixels and the data slice modifier 222 can fill the region based on an interpolation of pixels proximate the region.

In some embodiments, the image transmitter 224 can display modified light field data based on the merged plurality of data slices with the at least one filled region and a multi-panel blending technique. For example, the image transmitter 224 may separate the parallax-enhanced light field data or light field views into a plurality of frames per viewing angle, wherein each frame corresponds to one of the display panels. For example, each frame can correspond to a display panel that is to display a two dimensional image or content split from the three dimensional image based on a depth of the display panel. In some examples, the multi-panel blending technique and splitting parallax-enhanced light field data can occur simultaneously. In some embodiments, the image transmitter 224 can modify the plurality of frames based on a depth of each pixel in the three dimensional image to be displayed. For example, the image transmitter 224 can detect depth data, which can indicate a depth of pixels to be displayed within the three dimensional display device 100. For example, depth data can indicate that a pixel is to be displayed on a display panel of the three dimensional display device 100 closest to the user, a display panel farthest from the user, or any display panel between the closest display panel and the farthest display panel. In some examples, the image transmitter 224 can modify or blend pixels based on the depth of the pixels and modify pixels to prevent occluded background objects from being displayed. Blending techniques and occlusion techniques are described in greater detail below in relation to FIG. 3. Furthermore, the image transmitter 224 can display the three dimensional image based on modified light field data using the plurality of display panels. For example, the image transmitter 224 can transmit the modified plurality of frames to the corresponding display panels in the three dimensional display device 100. In some embodiments, the processors 202 can execute instructions from the image transmitter 224 and transmit the modified plurality of frames to a projector via the display interface 208, which can include any suitable graphics processing unit. In some examples, the modified plurality of frames are rendered by the graphics processing unit based on a 24 bit HDMI data stream at 60 Hz. The display interface 208 can transmit the modified plurality of frames to a projector, which can parse the frames based on a number of display panels in the three dimensional display device 100.

In some embodiments, the storage device 216 can also include a user detector 226 that can detect a viewing angle of a user based on a facial characteristic of the user. For example, the user detector 226 may detect facial characteristics, such as eyes, to determine a user's gaze. In some embodiments, the user detector 226 can determine a viewing angle of the user based on a distance between the user and the display device 100 and a direction of the user's eyes. The user detector 226 can continuously monitor a user's field of view or viewing angle and modify the display of the image accordingly. For example, the user detector 226 can modify the blending of frames of the image based on an angle from which the user views the three dimensional display device 100.

It is to be understood that the block diagram of FIG. 2 is not intended to indicate that the computing device 200 is to include all of the components shown in FIG. 2. Rather, the computing device 200 can include fewer or additional components not illustrated in FIG. 2 (e.g., additional memory components, embedded controllers, additional modules, additional network interfaces, etc.). For example, the computing device 200 can also include an image creator 228 to create computer generated light field images as discussed below in relation to FIG. 3. The computing device 200 can also include a calibration module 230 to calibrate display panels in a three dimensional display device 100 as discussed below in relation to FIG. 5. Furthermore, any of the functionalities of the image detector 218, disparity detector 220, data slice modifier 222, image transmitter 224, user detector 226, image creator 228, and calibration module 230 may be partially, or entirely, implemented in hardware and/or in the processor 202. For example, the functionality may be implemented with an application specific integrated circuit, logic implemented in an embedded controller, or in logic implemented in the processors 202, among others. In some embodiments, the functionalities of the image detector 218, disparity detector 220, data slice modifier 222, image transmitter 224, user detector 226, image creator 228, and calibration module 230 can be implemented with logic, wherein the logic, as referred to herein, can include any suitable hardware (e.g., a processor, among others), software (e.g., an application, among others), firmware, or any suitable combination of hardware, software, and firmware.

FIGS. 3A and 3B illustrate a process flow diagram for generating a three dimensional image to be displayed by a three dimensional display with multiple display panels and a projector. The methods 300A and 300B illustrated in FIGS. 3A and 3B can be implemented with any suitable computing component or device, such as the computing device 200 of FIG. 2 and the three dimensional display device 100 of FIG. 1.

Beginning with FIG. 3A, at block 302, the image detector 218 can detect light field data from any suitable device such as a plenoptic camera (also referred to as a light field camera) or any other device that can capture a light field view that includes an intensity of light in an image and a direction of the light fields in the image. In some embodiments, the camera capturing the light field data can include various sensors and lenses that enable viewing the image from different angles based on a captured intensity of light rays and direction of lights rays in the image. In some examples, the camera includes a lenslet or micro-lens array inserted at the image plane proximate the image sensor to retrieve angular information with a limited parallax. In some embodiments, the light field data is stored in a non-volatile memory device and processed asynchronously.

At block 304, the image detector 218 can preprocess the light field data. For example, the image detector 218 can extract raw images and apply denoising, color correction, and rectification techniques. In some embodiments, the raw images are captured as a rectangular grid from a micro-lens array that is based on a hexagonal grid.

At block 306, the disparity detector 220 can generate a plurality of disparity maps based on the light field data. For example, the disparity detector 220 can include lightweight matching functions that can detect disparities between angles of light field data based on horizontal and vertical pixel pairing techniques. The lightweight matching functions can compare pixels of multiple incidents in the light field views to determine a shift in pixels. In some examples, the disparity detector 220 can propagate results from pixel pairing to additional light field views to form multi-view disparity maps.

At block 308, the disparity detector 220 can convert each of the disparity maps to a depth map resulting in a plurality of depth maps. For example, the disparity detector 220 can detect a baseline and focal length of the camera used to capture the light field data. A baseline can indicate an amount of angular information a camera can capture corresponding to light field data. For example, the baseline can indicate that the light field data can be viewed by a range of angles. The focal length can indicate a distance between the center of a lens in a camera and a focal point. In some examples, the baseline and the focal length of the camera are unknown. The disparity detector 220 can detect the baseline and the focal length of the camera based on Equation 1 below:

Bf=max(z)(min(d)+d0) Equation 1

In equation 1, B can represent the baseline and f can represent the focal length of a camera. Additionally, z can represent a depth map and d can represent a disparity map. In some embodiments, max(z) can indicate a maximum distance in the image and min(z) can indicate a minimum distance in the image. The disparity detector 220 can detect the zero disparity plane d0 using Equation 2 below. The zero disparity plane can indicate which depth slice is to remain fixed without a shift. For example, the zero disparity plane can indicate a depth plane at which pixels are not shifted.

$$d 0 = \frac{min ( z ) max ( d ) - max ( z ) min ( d )}{max ( z ) - min ( z )} \qquad Equation 2$$

The min(d) and max(d) calculations of Equation 2 include detecting a minimum disparity of an image and a maximum disparity of an image respectively. In some example, the disparity detector 220 can detect a “z” value based on a disparity map d and normalize the z value between two values, such as zero and one, which can indicate a closest distance and a farthest distance respectively. For example, the disparity detector 220 can detect the z value by dividing a product of the baseline and focal length by a combination of a value in a disparity map and a value in a zero disparity plane. In some embodiments, depth maps can be stored as grey scale representations of the light field data, in which each different color shade indicates a different depth.

At block 310, the data slice modifier 222 can generate a plurality of data slices based on a viewing angle and a depth of content of the light field data, wherein the depth of content of the light field data is estimated from the plurality of depth maps. In some examples, the data slice modifier 222 can generate a number of uniformly spaced data slices based on any suitable predetermined number. In some embodiments, the data slice modifier 222 can generate data slices such that adjacent pixels in multiple data slices can be merged into one data slice. In some examples, the data slice modifier 222 can form one hundred data slices, or any other suitable number of data slices. The number of data slices may not have a one to one mapping to a number of display panels in the three dimensional display device.

At block 311, the data slice modifier 222 can shift the plurality of data slices per each viewing angle in at least one direction and at least one magnitude to create a plurality of shifted data slices. For example, the data slice modifier 222 can detect a viewing angle in relation to a three dimensional display device and shift the plurality of data slices based on the viewing angle. In some embodiments, the magnitude can correspond to the amount of shift in a data slice.

At block 312, the data slice modifier 222 can merge the plurality of shifted data slices based on a parallax determination and a user orientation proximate the plurality of display panels, wherein the merger of the plurality of shifted data slices results in at least one unrendered region. As discussed above, the parallax determination corresponds to shifting background objects in light field data based on a different viewpoint of a user. For example, the data slice modifier 222 can detect a maximum shift value in pixels, also referred to herein as D_Increment, which can be upper bounded by a physical viewing zone of a three dimensional display device. In some embodiments, a D_Increment value of zero can indicate that a user has not shifted the viewing angle of the three dimensional image displayed by the three dimensional display device. Accordingly, the data slice modifier 222 may not apply the parallax determination.

In some embodiments, the data slice modifier 222 can detect a reference depth plane corresponding to the zero disparity plane. The zero disparity plane (also referred to herein as ZRP) can indicate a pop-up mode, a center mode and a virtual mode. The pop-up mode can indicate pixels in a background display panel of the three dimensional display device are to be shifted more than pixels displayed on a display panel closer to the user. The center mode can indicate pixels displayed in one of any number of center display panels are to be shifted by an amount between the pop-up mode and the virtual mode. The virtual mode can indicate that pixels displayed on a front display panel closest to the user may be shifted the least.

In some embodiments, the data slice modifier 222 can translate data slices based on the zero disparity plane mode for each data slice. For example, the data slice modifier can calculate normalized angular coordinates that are indexed i and j in Equations 3 and 4 below:

T_{xi,k}=Angₓᵢ*(QuantDk−(1−ZDP))*D_Increment Equation 3

T_{yj,k}=Ang_{yj}*(QuantDk−(1−ZDP))*D_Increment Equation 4

In some embodiments, QuantD is a normalized depth map that is indexed by k. The results can be rounded to a nearest integer to enhance filling results in block 314 below. In some examples, a data slice of a central reference plane in the image may have no shift while a data slice from a viewpoint with a significant shift can result in larger shifts. For example, pixels can be shifted by an amount equal to D_Increment divided by four in center mode and D_Increment divided by two in pop-up mode or virtual mode.

In some embodiments, the data slice modifier 222 can merge data slices such that data slices closer to the user overwrite data slices farther from the user to support occlusion from the user's perspective of the displayed image. In some examples, the multi-view depth maps are also modified with data slicing, translation, and merging techniques to enable tracking depth values of modified views. In some embodiments, the parallax determination can increase a motion parallax supported over a range of viewing angles provided by the plurality display panels, wherein the plurality of display panels are to display the three dimensional image.

At block 314, the data slice modifier 222 can fill at least one unrendered region of the merged plurality of data slices with color values based on an interpolation of pixels proximate the at least one unrendered region. For example, a result of the parallax determination of block 312 can be unrendered pixels. In some examples, the unrendered pixels result from the data slice modifier 222 shifting pixels and overwriting pixels at a certain depth of the light field data with pixels in the front or foreground of the scene. As the light field data is shifted, regions of the light field data may not be rendered and may include missing values or black regions. The data slice modifier 222 can constrain data slice translation to integer values so that intensity values at data slice boundaries may not spread to neighboring pixels. In some embodiments, the data slice modifier 222 can generate a nearest interpolation of pixels surrounding an unrendered region. For example, the data slice modifier 222 can apply a median filtering with a region, such as three by three pixels, or any other suitable region size, which can remove noisy inconsistent pixels in the filled region. In some embodiments, the data slice modifier 222 can apply the region filling techniques to multi-view depth maps as well. In some examples, if a user has not shifted a viewing angle of the image displayed by the three dimensional display device, the data slice modifier 222 may not fill a region of the image.

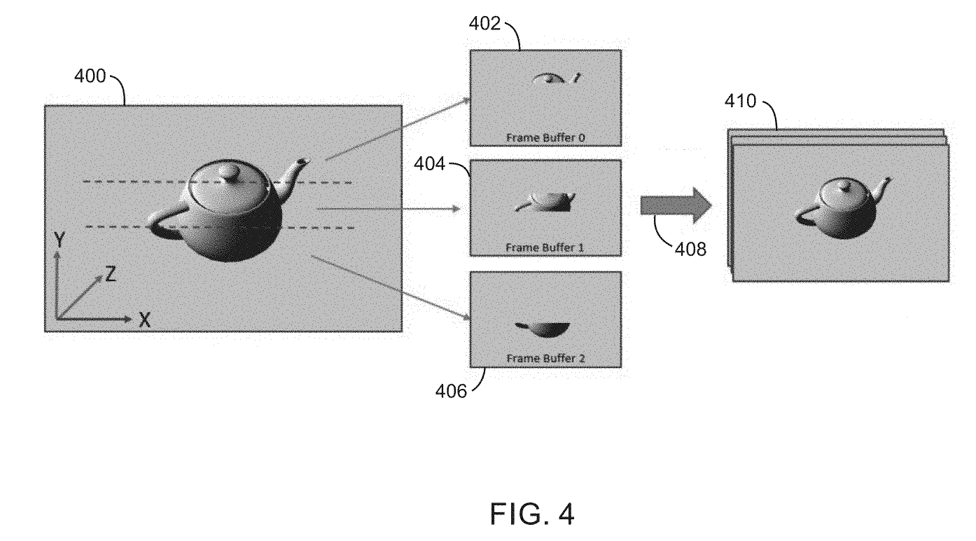

At block 316, the image transmitter 224 can project modified light field data as a three dimensional image based on the merged plurality of data slices with the at least one filled region, a multi-panel blending technique, and a multi-panel calibration technique described below in relation to block 322. In some examples, the multi-blending technique can include separating the three dimensional image into a plurality of frames, wherein each frame corresponds to one of the display panels. Each frame can correspond to a different depth of the three dimensional image to be displayed. For example, a portion of the three dimensional image closest to the user can be split or separated into a frame to be displayed by the display panel closest to the user. In some embodiments, the image transmitter 224 can use a viewing angle of the user to separate the three dimensional image. For example, the viewing angle of the user can indicate the amount of parallax for pixels from the three dimensional image, which can indicate which frame is to include the pixels. The frames are described in greater detail below in relation to FIG. 4.

In some examples, the blending technique can also include modifying the plurality of frames based on a depth of each pixel in the three dimensional image. For example, the image transmitter 224 can blend the pixels in the three dimensional image to enhance the display of the three dimensional image. The blending of the pixels can enable the three dimensional display device to display an image with additional depth features. For example, edges of objects in the three dimensional image can be displayed with additional depth characteristics based on blending pixels. In some embodiments, the image transmitter 224 can blend pixels based on formulas presented in Table 1 below, which correspond to two display panel blending techniques. In some examples, the multi-panel blending techniques include mapping the plurality of data slices to a number of data slices equal to the three display panels and adjusting a color for each pixel based on a depth of each pixel in relation to the three display panels.

TABLE 1

| Vertex Z | | | |
|---|---|---|---|
| value | Front panel | Middle panel | Back panel |
| Z < T₀ | blend = 1 | Transparent pixel | Transparent pixel |
| T₀ ≤ Z < T₁ | $blend = \frac{{T}_{1} - Z}{{T}_{1} - {T}_{0}}$ | $blend = \frac{Z - {T}_{0}}{{T}_{1} - {T}_{0}}$ | Transparent pixel |
| T₁ ≤ Z ≤ T₂ | blend = 0 | $blend = \frac{{T}_{2} - Z}{{T}_{2} - {T}_{1}}$ | $blend = \frac{Z - {T}_{1}}{{T}_{2} - {T}_{1}}$ |
| Z > T₂ | blend = 0 | blend = 0 | blend = 1 |

In Table 1, the Z value indicates a depth of a pixel to be displayed and values T0, T1, and T2 correspond to depth thresholds indicating a display panel to display the pixels. For example, T0 can correspond to pixels to be displayed with the display panel closest to the user, T1 can correspond to pixels to be displayed with the center display panel between the closest display panel to the user and the farthest display panel to the user, and T2 can correspond to pixels to be displayed with the farthest display panel from the user. In some embodiments, each display panel includes a corresponding pixel shader, which is executed for each pixel or vertex of the three dimensional model. Each pixel shader can generate a color value to be displayed for each pixel. In some embodiments, the threshold values T0, T1, and T2 can be determined based on uniform, Otsu, K-means, or equal-counts techniques.

Still at block 316, in some embodiments, the image transmitter 224 can detect that a pixel value corresponds to at least two of the display panels, detect that the pixel value corresponds to an occluded object, and modify the pixel value by displaying transparent pixels on one of the display panels farthest from the user. An occluded object, as referred to herein, can include any background object that should not be viewable to a user. In some examples, the pixels with Z<T0 can be sent to the pixel shader for each display panel. The front display panel pixel shader can render a pixel with normal color values, which is indicated with a blend value of one. In some examples, the middle or center display panel pixel shader and back display panel pixel shader also receive the same pixel value. However, the center display panel pixel shader and back display panel pixel shader can display the pixel as a transparent pixel by converting the pixel color to white. Displaying a white pixel can prevent occluded pixels from contributing to an image. Therefore, for a pixel rendered on a front display panel, the pixels directly behind the front pixel may not provide any contribution to the perceived image. The occlusion techniques described herein prevent background objects from being displayed if a user should not be able to view the background objects.

Still at block 316, in some embodiments, the image transmitter 224 can also blend a pixel value between two of the plurality of display panels. For example, the image modifier 222 can blend pixels with a pixel depth Z between T0 and T1 to be displayed on the front display panel and the middle display panel. For example, the front display panel can display pixel colors based on values indicated by dividing a second threshold value (T1) minus a pixel depth by the second threshold value minus a first threshold value (T0). The middle display panel can display pixel colors based on dividing a pixel depth minus the first threshold value by the second threshold value minus the first threshold value. The back display panel can render a white value to indicate a transparent pixel. In some examples, blending colored images can use the same techniques as blending grey images.

In some embodiments, when the pixel depth Z is between T1 and T2, the front display panel can render a pixel color based on a zero value for blend. In some examples, setting blend equal to zero effectively discards a pixel which does not need to be rendered and has no effect on the pixels located farther away from the user or in the background. The middle display panel can display pixel colors based on values indicated by dividing a third threshold value (T2) minus a pixel depth by the third threshold value minus a second threshold value (T0). The back display panel can display pixel colors based on dividing a pixel depth minus the second threshold value by the third threshold value minus the second threshold value. In some embodiments, if a pixel depth Z is greater than the third threshold T2, the pixels can be discarded from the front and middle display panels, while the back display panel can render normal color values.

In some embodiments, the image transmitter 224 can blend pixels for more than two display panels together. For example, the image transmitter 224 can calculate weights for each display panel based on the following equations:

W₁=1−|Z−T₀| Equation 5

W₂=1−|Z−T₁| Equation 6

W₃=1−|Z−T₂| Equation 7

The image transmitter can then calculate an overall weight W by adding W1, W2, and W3. Each pixel can then be displayed based on a weighted average calculated by the following equations, wherein W1*, W2*, and W3* indicate pixel colors to be displayed on each of three display panels in the three dimensional display device.

$$\begin{matrix}{W}_{1} *= \frac{{W}_{1}}{W} & Equation 8 \\ {W}_{2} *= \frac{{W}_{2}}{W} & Equation 9 \\ {W}_{3} *= \frac{{W}_{3}}{W} & Equation 10\end{matrix}$$

The process flow of FIG. 3A at block 316 continues at block 318 of FIG. 3B, wherein the user detector 226 can detect a viewing angle of a user based on a face tracking algorithm or facial characteristic of the user. In some embodiments, the user detector 226 can use any combination of sensors and cameras to detect a presence of a user proximate a three dimensional display device. In response to detecting a user, the user detector 226 can detect facial features of the user, such as eyes, and an angle of the eyes in relation to the three dimensional display device. The user detector 226 can detect the viewing angle of the user based on the direction in which the eyes of the user are directed and a distance of the user from the three dimensional display device. In some examples, the user detector 226 can also monitor the angle between the facial feature of the user and the plurality display panels and adjust the display of the modified image in response to detecting a change in the viewing angle.

At block 320, the image transmitter 224 can synthesize an additional view of the three dimensional image based on a user's viewing angle. For example, the image transmitter 224 can use linear interpolation to enable smooth transitions between the image rendering from different angles.

At block 322, the image transmitter 224 can use a multi-panel calibration technique to calibrate content or a three dimensional image to be displayed by display panels within the three dimensional display device. For example, the image transmitter 224 can select one display panel to be used for calibrating the additional display panels in the three dimensional display device. The image transmitter 224 can calibrate display panels for a range of angles for viewing an image at a predetermined distance. The image transmitter 224 can then apply a linear fitting model to derive calibration parameters of a tracked user's position. The image transmitter 224 can then apply a homographic or affine transformation to each data slice to impose alignment in scale and translation for the image rendered on the display panels. The calibration techniques are described in greater detail below in relation to FIG. 5.

At block 324, the image transmitter 224 can display the three dimensional image using the plurality of display panels. For example, the image transmitter 224 can send the calibrated pixel values generated based on Table 1 or equations 8, 9, and 10 to the corresponding display panels of the three dimensional display device. For example, each pixel of each of the display panels may render a transparent color of white, a normal pixel color corresponding to a blend value of one, a blended value between two proximate display panels, a blended value between more than two display panels, or a pixel may not be rendered. In some embodiments, the image transmitter 224 can update the pixel values at any suitable rate, such as 180 Hz, among others, and using any suitable technique. The process can continue at block 318 by continuing to monitor the viewing angle of the user and modifying the three dimensional image accordingly.

The process flow diagram of FIG. 3 is not intended to indicate that the operations of the method 300 are to be executed in any particular order, or that all of the operations of the method 300 are to be included in every case. Additionally, the method 300 can include any suitable number of additional operations. In some embodiments, the user detector 226 can detect a distance and an angle between the user and the multi-panel display. In some examples, the method 300 can include generating the plurality of data slices based on at least one integer translation between adjacent data slices, wherein each data slice represents pixels of the light field data belonging to a quantized depth plane.

In some embodiments, an image creator or rendering application can generate a three dimensional object to be used as the image. In some examples, an image creator can use any suitable image rendering software to create a three dimensional image. In some examples, the image creator can detect a two dimensional image and generate a three dimensional image from the two dimensional image. For example, the image creator can transform the two dimensional image by generating depth information for the two dimensional image to result in a three dimensional image. In some examples, the image creator can also detect a three dimensional image from any camera device that captures images in three dimensions. In some embodiments, the image creator can also generate a light field for the image and multi-view depth maps. Projecting or displaying the computer-generated light field image may not include applying the parallax determination, data slice generation, and data filling described above because the computer-generated light field can include information to display the light field image from any angle. Accordingly, the computer-generated light field images can be transmitted directly to the multi-panel blending stage to be displayed. In some embodiments, the display of the computer-generated light field image can be shifted or modified as a virtual camera in the image creator software is shifted within an environment.

FIG. 4 is an example of three dimensional content. The content 400 illustrates an example image of a teapot to be displayed by a three dimensional display device 100. In some embodiments, the computing device 200 of FIG. 2 can generate the three dimensional image of a teapot as a two dimensional image comprising at least three frames, wherein each frame corresponds to a separate display panel. For example, frame buffer 400 can include a separate two dimensional image for each display panel of a three dimensional display device. In some embodiments, frames 402, 404, and 406 are included in a two dimensional rendering of the content 400. For example, the frames 402, 404, and 406 can be stored in a two dimensional environment that has a viewing region three times the size of the display panels. In some examples, the frames 402, 404, and 406 can be stored proximate one another such that frames 402, 404, and 406 can be viewed and edited in rendering software simultaneously.

In the example of FIG. 4, the content 400 includes three frames 402, 404, and 406 that can be displayed with three separate display panels. As illustrated in FIG. 4, the pixels to be displayed by a front display panel that is closet to a user are separated into frame 402. Similarly, the pixels to be displayed by a middle display panel are separated into frame 404, and the pixels to be displayed by a back display panel farthest from a user are separated into frame 406.

In some embodiments, the blending techniques and occlusion modifications described in FIG. 3 above can be applied to frames 402, 404, and 406 of the frame buffer 400 as indicated by arrow 408. The result of the blending techniques and occlusion modification is a three dimensional image 410 displayed with multiple display panels of a three dimensional display device.

It is to be understood that the frame buffer 400 can include any suitable number of frames depending on a number of display panels in a three dimensional display device. For example, the content 400 may include two frames for each image to be displayed, four frames, or any other suitable number.

FIG. 5 is an example image depicting alignment and calibration of a three dimensional display using multiple display panels and a projector. The alignment and calibration techniques can be applied to any suitable display device such as the three dimensional display device 100 of FIG. 1.

In some embodiments, a calibration module 500 can adjust a displayed image. In some examples, a projector's 502 axis is not aligned with the center of the display panels 504, 506, and 508 and the projected beam 510 can be diverged during the projected beam's 510 propagation through the display panels 504, 506, and 508. This means that the content projected onto the display panels 504, 506, and 508 may no longer be aligned and the amount of misalignment may differ according to the viewer position.

To maintain alignment, the calibration module 500 can calibrate each display panel 504, 506, and 508. The calibration module 500 can select one of the display panels 504, 506, or 508 with a certain view to be a reference to which the content of other display panels are aligned. The calibration module 500 can also detect a calibration pattern to adjust a scaling and translation of each display panel 504, 506, and 508. For example, the calibration module 500 can detect a scaling tuple (Sₓ, S_{y}) and a translation tuple (Tₓ, T_{y}) and apply an affine transformation on the pixels displaying content for other display panels 504, 506, or 508. The affine transformation can be based on Equation 11 below:

$$Affine Transformation = [ \begin{matrix}{S}_{x} & 0 & 0 \\ 0 & {S}_{y} & 0 \\ {T}_{x} & {T}_{y} & 1\end{matrix} ] \qquad Equation 11$$

In some examples, the calibration module 500 can apply the affine transformation for each display panel 504, 506, and 508 for a single viewing position until the content is aligned with the calibration pattern on the reference panel. In some examples, the calibration module 500 can detect an affine transformation for a plurality of data slices from the image, wherein the affine transformation imposes alignment in scale and translation of the image for each of the three display panels. In some embodiments, the scaling tuple is implicitly spatially up sampling the captured light field images to fit the spatial resolution of the projector 502 utilized in the multi-panel display. This calibration process can be reiterated for selected viewing angles covering any number of viewing angles at any suitable distance to find calibration parameters per panel per view. In some embodiments, the calibration module 500 can use the calibration tuples or parameters and a linear fitting polynomial, or any other suitable mathematical technique, to derive the calibration parameters at any viewing angle.

In some embodiments, for a given viewer's position, the interpolated view can undergo a set of affine transformations with calibration parameters derived from the fitted polynomial. The calibration module 500 can perform the affine transformation interactively with the viewer's position to impose alignment in scale and translation on the rendered image or content for the display panels 504, 506, and 508. For example, the calibration module 500 can project an image or content 512 at a distance 514 from the projector 502, wherein the content 512 can be viewable from various angles. In some examples, the image or content 512 can have any suitable width 516 and height 518.

It is to be understood that the block diagram of FIG. 5 is not intended to indicate that the calibration system 500 is to include all of the components shown in FIG. 5. Rather, the calibration system 500 can include fewer or additional components not illustrated in FIG. 5 (e.g., additional display panels, additional alignment indicators, etc.).

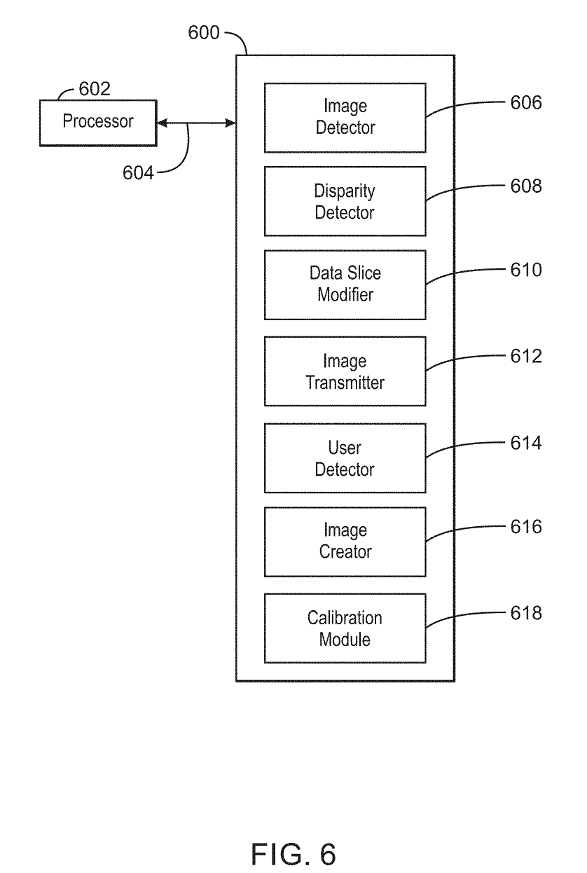

FIG. 6 is an example block diagram of a non-transitory computer readable media for generating a three dimensional image to be displayed by a three dimensional display with multiple display panels and a projector. The tangible, non-transitory, computer-readable medium 600 may be accessed by a processor 602 over a computer interconnect 604. Furthermore, the tangible, non-transitory, computer-readable medium 600 may include code to direct the processor 602 to perform the operations of the current method.

The various software components discussed herein may be stored on the tangible, non-transitory, computer-readable medium 600, as indicated in FIG. 6. For example, an image detector 606 can detect a light field data. In some examples, a disparity detector 608 can generate a plurality of disparity maps based on the light field data. For example, the disparity detector 608 can compare light field data from different angles to detect a shift of each pixel. In some embodiments, the disparity detector 608 can also convert each of the disparity maps to a depth map. For example, the disparity detector 608 can detect a zero disparity plane and a baseline and a focal length of a camera that captured the light field data.

In some embodiments, a data slice modifier 610 can generate a plurality of data slices based on a viewing angle and a depth content of the light field data, wherein the depth content of the light field data is estimated from the plurality of depth maps. As discussed above, each data slice can represent pixels grouped based on a depth plane and viewing angle of a user. In some embodiments, the data slice modifier 610 can shift the plurality of data slices per the viewing angle in at least one direction and at least one magnitude to create a plurality of shifted data slices. The data slice modifier 610 can also merge the plurality of shifted data slices based on a parallax determination and a user orientation proximate the plurality of display panels, wherein the merger of the shifted plurality of data slices results in at least one unrendered region. For example, the data slice modifier 610 can overwrite background objects and occluded objects or objects that should not be visible to a user.

In some embodiments, the data slice modifier 610 can also fill at least one unrendered region of the merged plurality of data slices with color values based on an interpolation of pixels proximate the at least one unrendered region. For example, the data slice modifier 610 can detect a shift in the data slices that has resulted in unrendered pixels and the data slice modifier 610 can fill the region based on an interpolation of pixels proximate the region.

In some embodiments, an image transmitter 612 can display modified light field data based on the merged plurality of data slices with the at least one filled region and a multi-panel blending technique. For example, the image transmitter 612 may separate the three dimensional image into a plurality of frames, wherein each frame corresponds to one of the display panels. For example, each frame can correspond to a display panel that is to display a two dimensional image split from the three dimensional image based on a depth of the display panel. Furthermore, the image transmitter 612 can display the three dimensional image using the plurality of display panels. For example, the image transmitter 612 can transmit the modified plurality of frames to the corresponding display panels in the three dimensional display device.

In some embodiments, a user detector 614 that can detect a viewing angle of a user based on a facial characteristic of the user. For example, the user detector 614 may detect facial characteristics, such as eyes, to determine a user's gaze. The user detector 614 can also determine a viewing angle to enable a three dimensional image to be properly displayed. The user detector 614 can continuously monitor a user's viewing angle and modify the display of the image accordingly. For example, the user detector 614 can modify the blending of frames of the image based on an angle from which the user views the three dimensional display device.

In some embodiments, the tangible, non-transitory, computer-readable medium 600 can also include an image creator 616 to create computer generated light field images as discussed above in relation to FIG. 3. In some examples, the tangible, non-transitory, computer-readable medium 600 can also include a calibration module 618 to calibrate display panels in a three dimensional display device as discussed above in relation to FIG. 5

It is to be understood that any suitable number of the software components shown in FIG. 6 may be included within the tangible, non-transitory computer-readable medium 600. Furthermore, any number of additional software components not shown in FIG. 6 may be included within the tangible, non-transitory, computer-readable medium 600, depending on the specific application.

### Example 1

In some examples, a system for multi-panel displays can include a projector, a plurality of display panels, and a processor that can generate a plurality of disparity maps based on light field data. The processor can also convert each of the plurality of disparity maps to a separate depth map, generate a plurality of data slices for a plurality of viewing angles based on the depth maps of content from the light field data, and shift the plurality of data slices for each of the viewing angles in at least one direction or at least one magnitude. The processor can also merge the plurality of shifted data slices based on a parallax determination and a user orientation proximate the plurality of display panels and fill at least one unrendered region of the merged plurality of data slices with color values based on an interpolation of proximate pixels. Furthermore, the processor can display a three dimensional image based on the merged plurality of data slices with the at least one filled region.

### Example 2

The system of Example 1, wherein the processor is to apply denoising, rectification, or color correction to the light field data.

### Example 3

The system of Example 1, wherein the processor is to detect a facial feature of a user and determine a viewing angle of the user in relation to the plurality display panels.

### Example 4

The system of Example 3, wherein the processor is to monitor the viewing angle of the user and the plurality display panels and adjust the display of the three dimensional image in response to detecting a change in the viewing angle.

### Example 5

The system of Example 1, wherein the processor is to apply an affine transformation on the merged plurality of data slices, wherein the affine transformation imposes alignment in scale and translation for each of the display panels.

### Example 6

The system of Example 1, wherein the processor is to detect the light field data from a light field camera, an array of cameras, or a computer generated light field image from rendering software.

### Example 7

The system of Example 1, wherein the parallax determination is to increase a motion parallax supported over a range of viewing angles provided by the plurality display panels, wherein the plurality of display panels are to display the three dimensional image.

### Example 8

The system of Example 1, wherein the processor is to generate the plurality of data slices based on at least one integer translation between adjacent data slices, wherein each data slice represents pixels of the light field data belonging to a quantized depth plane.

### Example 9

The system of Example 1, wherein to display the three dimensional image the processor is to execute a multi-panel blending technique comprising mapping the plurality of data slices to a number of data slices equal to a number of display panels and adjusting a color for each pixel based on a depth of each pixel in relation to the display panels.

### Example 10

The system of Example 1, wherein the plurality of display panels comprises two liquid crystal display panels, three liquid crystal display panels, or four liquid crystal display panels.

### Example 11

The system of Example 1, comprising a reimaging plate to display the three dimensional image based on display output from the plurality of display panels.

### Example 12

The system of Example 1, wherein to display the three dimensional image the processor is to execute a multi-calibration technique comprising selecting one of the plurality of display panels to be used for calibrating the plurality of display panels and using a linear fitting model to derive calibration parameters of a tracked user's position.

### Example 13

In some embodiments, a method for displaying three dimensional images can include generating a plurality of disparity maps based on light field data and converting each of the disparity maps to a depth map resulting in a plurality of depth maps. The method can also include generating a plurality of data slices for a plurality of viewing angles based on a depth of content of the light field data, wherein the depth of content of the light field data is estimated from the plurality of depth maps and shifting the plurality of data slices for each viewing angle in at least one direction or at least one magnitude to create a plurality of shifted data slices. Furthermore, the method can include merging the plurality of shifted data slices based on a parallax determination and a user orientation proximate the plurality of display panels, wherein the merger of the plurality of data slices results in at least one unrendered region. In addition, the method can include filling the at least one unrendered region of the merged plurality of data slices with color values based on an interpolation of pixels proximate the at least one unrendered region and displaying a three dimensional image based on the merged plurality of data slices with the at least one filled region.

### Example 14

The method of Example 13 comprising detecting a facial feature of a user and determining a viewing angle of the user in relation to the plurality display panels.

### Example 15

The method of Example 13, comprising applying an affine transformation on the merged plurality of data slices, wherein the affine transformation imposes alignment in scale and translation for each of the display panels.

### Example 16

The method of Example 13 comprising detecting the light field data from a light field camera, an array of cameras, or a computer generated light field image from rendering software.

### Example 17

The method of Example 13, wherein the parallax determination increases a motion parallax supported over a range of viewing angles provided by the plurality display panels, wherein the plurality of display panels are to display the three dimensional image.

### Example 18

The method of Example 13, comprising generating the plurality of data slices based on at least one integer translation between adjacent data slices, wherein each data slice represents pixels of the light field data belonging to a quantized depth plane.

### Example 19

The method of Example 13, wherein displaying the three dimensional image comprises a multi-panel blending technique comprising mapping the plurality of data slices to a number of data slices equal to a number of display panels and adjusting a color for each pixel based on a depth of each pixel in relation to the plurality of display panels.

### Example 20

The method of Example 13, wherein the three dimensional image is based on display output from the plurality of display panels.

### Example 21

The method of Example 13, wherein displaying the three dimensional image comprises executing a multi-calibration technique comprising selecting one of the plurality of display panels to be used for calibrating the plurality of display panels and using a linear fitting model to derive calibration parameters of a tracked user's position.

### Example 22

In some embodiments, a non-transitory computer-readable medium for displaying three dimensional light field data can include a plurality of instructions that in response to being executed by a processor, cause the processor to generate a plurality of disparity maps based on light field data. The plurality of instructions can also cause the processor to convert each of the disparity maps to a separate depth map resulting in a plurality of depth maps and generate a plurality of data slices for a range of viewing angles based on a depth of content of the light field data, wherein the depth of content of the light field data is estimated from the plurality of depth maps. Additionally, the plurality of instructions can cause the processor to shift the plurality of data slices for each viewing angle in at least one direction and at least one magnitude to create a plurality of shifted data slices, and merge the plurality of shifted data slices based on a parallax determination and a user orientation proximate the plurality of display panels, wherein the merger of the plurality of data slices results in at least one unrendered region. Furthermore, the plurality of instructions can cause the processor to fill the at least one unrendered region of the merged plurality of data slices with color values based on an interpolation of pixels proximate the at least one unrendered region, and display a three dimensional image based on the merged plurality of data slices with the at least one filled region.

### Example 23

The non-transitory computer-readable medium of Example 22, wherein the plurality of instructions cause the processor to generate the plurality of data slices based on at least one integer translation between adjacent data slices, wherein each data slice represents pixels of the light field data belonging to a quantized depth plane.

### Example 24

The non-transitory computer-readable medium of Example 22, wherein the plurality of instructions cause the processor to display the three dimensional image using a multi-panel blending technique comprising mapping the plurality of data slices to a number of data slices equal to a number of display panels and adjusting a color for each pixel based on a depth of each pixel in relation to the plurality of display panels.

### Example 25

The non-transitory computer-readable medium of Example 22, wherein displaying the three dimensional image comprises executing a multi-panel blending technique and a multi-panel calibration technique.

### Example 26

In some embodiments, a system for multi-panel displays can include a projector, a plurality of display panels, and a processor comprising means for generating a plurality of disparity maps based on light field data and means for converting each of the plurality of disparity maps to a separate depth map. The processor can also comprise means for generating a plurality of data slices for a plurality of viewing angles based on the depth maps of content from the light field data, means for shifting the plurality of data slices for each of the viewing angles in at least one direction or at least one magnitude, and means for merging the plurality of shifted data slices based on a parallax determination and a user orientation proximate the plurality of display panels. Additionally, the processor can include means for filling at least one unrendered region of the merged plurality of data slices with color values based on an interpolation of proximate pixels, and means for displaying a three dimensional image based on the merged plurality of data slices with the at least one filled region.

### Example 27

The system of Example 26, wherein the processor comprises means for applying denoising, rectification, or color correction to the light field data.

### Example 28

The system of Example 26, wherein the processor comprises means for detecting a facial feature of a user and determining a viewing angle of the user in relation to the plurality display panels.

### Example 29

The system of Example 28, wherein the processor comprises means for monitoring the viewing angle of the user and the plurality display panels and adjusting the display of the three dimensional image in response to detecting a change in the viewing angle.

### Example 30

The system of Example 26, 27, 28, or 29, wherein the processor comprises means for applying an affine transformation on the merged plurality of data slices, wherein the affine transformation imposes alignment in scale and translation for each of the display panels.

### Example 31

The system of Example 26, 27, 28, or 29, wherein the processor comprises means for detecting the light field data from a light field camera, an array of cameras, or a computer generated light field image from rendering software.

### Example 32

The system of Example 26, 27, 28, or 29, wherein the parallax determination is to increase a motion parallax supported over a range of viewing angles provided by the plurality display panels, wherein the plurality of display panels are to display the three dimensional image.

### Example 33

The system of Example 26, 27, 28, or 29, wherein the processor comprises means for generating the plurality of data slices based on at least one integer translation between adjacent data slices, wherein each data slice represents pixels of the light field data belonging to a quantized depth plane.

### Example 34

The system of Example 26, 27, 28, or 29, wherein to display the three dimensional image the processor comprises means for executing a multi-panel blending technique comprises mapping the plurality of data slices to a number of data slices equal to a number of display panels and adjusting a color for each pixel based on a depth of each pixel in relation to the display panels.

### Example 35

The system of Example 26, 27, 28, or 29, wherein the plurality of display panels comprises two liquid crystal display panels, three liquid crystal display panels, or four liquid crystal display panels.

### Example 36

The system of Example 26, 27, 28, or 29, comprising a reimaging plate comprising means for displaying the three dimensional image based on display output from the plurality of display panels.

### Example 37

The system of Example 26, 27, 28, or 29, wherein to display the three dimensional image the processor comprises means for executing a multi-calibration technique comprising selecting one of the plurality of display panels to be used for calibrating the plurality of display panels and using a linear fitting model to derive calibration parameters of a tracked user's position.

### Example 38

In some embodiments, a method for displaying three dimensional images can include generating a plurality of disparity maps based on light field data and converting each of the disparity maps to a depth map resulting in a plurality of depth maps. The method can also include generating a plurality of data slices for a plurality of viewing angles based on a depth of content of the light field data, wherein the depth of content of the light field data is estimated from the plurality of depth maps and shifting the plurality of data slices for each viewing angle in at least one direction or at least one magnitude to create a plurality of shifted data slices. Furthermore, the method can include merging the plurality of shifted data slices based on a parallax determination and a user orientation proximate the plurality of display panels, wherein the merger of the plurality of data slices results in at least one unrendered region. In addition, the method can include filling the at least one unrendered region of the merged plurality of data slices with color values based on an interpolation of pixels proximate the at least one unrendered region and displaying a three dimensional image based on the merged plurality of data slices with the at least one filled region.

### Example 39

The method of Example 38 comprising detecting a facial feature of a user and determining a viewing angle of the user in relation to the plurality display panels.

### Example 40

The method of Example 38, comprising applying an affine transformation on the merged plurality of data slices, wherein the affine transformation imposes alignment in scale and translation for each of the display panels.

### Example 41

The method of Example 38 comprising detecting the light field data from a light field camera, an array of cameras, or a computer generated light field image from rendering software.

### Example 42

The method of Example 38, 39, 40, or 41, wherein the parallax determination increases a motion parallax supported over a range of viewing angles provided by the plurality display panels, wherein the plurality of display panels are to display the three dimensional image.

### Example 43

The method of Example 38, 39, 40, or 41, comprising generating the plurality of data slices based on at least one integer translation between adjacent data slices, wherein each data slice represents pixels of the light field data belonging to a quantized depth plane.

### Example 44

The method of Example 38, 39, 40, or 41, wherein displaying the three dimensional image comprises a multi-panel blending techniques comprises mapping the plurality of data slices to a number of data slices equal to a number of display panels and adjusting a color for each pixel based on a depth of each pixel in relation to the plurality of display panels.

### Example 45

The method of Example 38, 39, 40, or 41, wherein the three dimensional image is based on display output from the plurality of display panels.

### Example 46

The method of Example 38, 39, 40, or 41, wherein displaying the three dimensional image comprises executing a multi-calibration technique comprising selecting one of the plurality of display panels to be used for calibrating the plurality of display panels and using a linear fitting model to derive calibration parameters of a tracked user's position.

### Example 47

In some embodiments, a non-transitory computer-readable medium for displaying three dimensional light field data can include a plurality of instructions that in response to being executed by a processor, cause the processor to generate a plurality of disparity maps based on light field data. The plurality of instructions can also cause the processor to convert each of the disparity maps to a separate depth map resulting in a plurality of depth maps and generate a plurality of data slices for a range of viewing angles based on a depth of content of the light field data, wherein the depth of content of the light field data is estimated from the plurality of depth maps. Additionally, the plurality of instructions can cause the processor to shift the plurality of data slices for each viewing angle in at least one direction and at least one magnitude to create a plurality of shifted data slices, and merge the plurality of shifted data slices based on a parallax determination and a user orientation proximate the plurality of display panels, wherein the merger of the plurality of data slices results in at least one unrendered region. Furthermore, the plurality of instructions can cause the processor to fill the at least one unrendered region of the merged plurality of data slices with color values based on an interpolation of pixels proximate the at least one unrendered region, and display a three dimensional image based on the merged plurality of data slices with the at least one filled region.

### Example 48

The non-transitory computer-readable medium of Example 47, wherein the plurality of instructions cause the processor to generate the plurality of data slices based on at least one integer translation between adjacent data slices, wherein each data slice represents pixels of the light field data belonging to a quantized depth plane.

### Example 49

The non-transitory computer-readable medium of Example 47 or 48, wherein the plurality of instructions cause the processor to display the three dimensional image using a multi-panel blending techniques comprises mapping the plurality of data slices to a number of data slices equal to a number of display panels and adjusting a color for each pixel based on a depth of each pixel in relation to the plurality of display panels.

### Example 50

The non-transitory computer-readable medium of Example 47 or 48, wherein displaying the three dimensional image comprises executing a multi-panel blending technique and a multi-panel calibration technique.

Although an example embodiment of the disclosed subject matter is described with reference to block and flow diagrams in FIGS. 1-6, persons of ordinary skill in the art will readily appreciate that many other methods of implementing the disclosed subject matter may alternatively be used. For example, the order of execution of the blocks in flow diagrams may be changed, and/or some of the blocks in block/flow diagrams described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

What is claimed is:

1. A system for multi-panel displays comprising:
a projector, a plurality of display panels, and a processor to:
generate a plurality of disparity maps based on light field data;
convert each of the plurality of disparity maps to a separate depth map;
generate a plurality of data slices for a plurality of viewing angles based on the depth maps of content from the light field data;
shift the plurality of data slices for each of the viewing angles in at least one direction or at least one magnitude;
merge the plurality of shifted data slices based on a parallax determination and a user orientation proximate the plurality of display panels;
fill at least one unrendered region of the merged plurality of data slices with color values based on an interpolation of proximate pixels; and
display a three dimensional image based on the merged plurality of data slices with the at least one filled region.

2. The system of claim 1, wherein the processor is to apply denoising, rectification, or color correction to the light field data.

3. The system of claim 1, wherein the processor is to detect a facial feature of a user and determine a viewing angle of the user in relation to the plurality display panels.

4. The system of claim 3, wherein the processor is to monitor the viewing angle of the user and the plurality display panels and adjust the display of the three dimensional image in response to detecting a change in the viewing angle.

5. The system of claim 1, wherein the processor is to apply an affine transformation on the merged plurality of data slices, wherein the affine transformation imposes alignment in scale and translation for each of the display panels.

6. The system of claim 1, wherein the processor is to detect the light field data from a light field camera, an array of cameras, or a computer generated light field image from rendering software.

7. The system of claim 1, wherein the parallax determination is to increase a motion parallax supported over a range of viewing angles provided by the plurality display panels, wherein the plurality of display panels are to display the three dimensional image.

8. The system of claim 1, wherein the processor is to generate the plurality of data slices based on at least one integer translation between adjacent data slices, wherein each data slice represents pixels of the light field data belonging to a quantized depth plane.

9. The system of claim 1, wherein to display the three dimensional image the processor is to execute a multi-panel blending technique comprising mapping the plurality of data slices to a number of data slices equal to a number of display panels and adjusting a color for each pixel based on a depth of each pixel in relation to the display panels.

10. The system of claim 1, wherein the plurality of display panels comprises two liquid crystal display panels, three liquid crystal display panels, or four liquid crystal display panels.

11. The system of claim 1, comprising a reimaging plate to display the three dimensional image based on display output from the plurality of display panels.

12. The system of claim 1, wherein to display the three dimensional image the processor is to execute a multi-calibration technique comprising selecting one of the plurality of display panels to be used for calibrating the plurality of display panels and using a linear fitting model to derive calibration parameters of a tracked user's position.

13. A method for displaying three dimensional images comprising:
generating a plurality of disparity maps based on light field data;
converting each of the disparity maps to a depth map resulting in a plurality of depth maps;
generating a plurality of data slices for a plurality of viewing angles based on a depth of content of the light field data, wherein the depth of content of the light field data is estimated from the plurality of depth maps;
shifting the plurality of data slices for each viewing angle in at least one direction or at least one magnitude to create a plurality of shifted data slices;
merging the plurality of shifted data slices based on a parallax determination and a user orientation proximate the plurality of display panels, wherein the merger of the plurality of data slices results in at least one unrendered region;
filling the at least one unrendered region of the merged plurality of data slices with color values based on an interpolation of pixels proximate the at least one unrendered region; and
displaying a three dimensional image based on the merged plurality of data slices with the at least one filled region.

14. The method of claim 13 comprising detecting a facial feature of a user and determining a viewing angle of the user in relation to the plurality display panels.

15. The method of claim 13, comprising applying an affine transformation on the merged plurality of data slices, wherein the affine transformation imposes alignment in scale and translation for each of the display panels.

16. The method of claim 13 comprising detecting the light field data from a light field camera, an array of cameras, or a computer generated light field image from rendering software.

17. The method of claim 13, wherein the parallax determination increases a motion parallax supported over a range of viewing angles provided by the plurality display panels, wherein the plurality of display panels are to display the three dimensional image.

18. The method of claim 13, comprising generating the plurality of data slices based on at least one integer translation between adjacent data slices, wherein each data slice represents pixels of the light field data belonging to a quantized depth plane.

19. The method of claim 13, wherein displaying the three dimensional image comprises a multi-panel blending technique comprising mapping the plurality of data slices to a number of data slices equal to a number of display panels and adjusting a color for each pixel based on a depth of each pixel in relation to the plurality of display panels.

20. The method of claim 13, wherein the three dimensional image is based on display output from the plurality of display panels.

21. The method of claim 13, wherein displaying the three dimensional image comprises executing a multi-calibration technique comprising selecting one of the plurality of display panels to be used for calibrating the plurality of display panels and using a linear fitting model to derive calibration parameters of a tracked user's position.

22. A non-transitory computer-readable medium for displaying three dimensional light field data comprising a plurality of instructions that in response to being executed by a processor, cause the processor to:
generate a plurality of disparity maps based on light field data;
convert each of the disparity maps to a separate depth map resulting in a plurality of depth maps;
generate a plurality of data slices for a range of viewing angles based on a depth of content of the light field data, wherein the depth of content of the light field data is estimated from the plurality of depth maps;
shift the plurality of data slices for each viewing angle in at least one direction and at least one magnitude to create a plurality of shifted data slices;
merge the plurality of shifted data slices based on a parallax determination and a user orientation proximate the plurality of display panels, wherein the merger of the plurality of data slices results in at least one unrendered region;
fill the at least one unrendered region of the merged plurality of data slices with color values based on an interpolation of pixels proximate the at least one unrendered region; and
display a three dimensional image based on the merged plurality of data slices with the at least one filled region.

23. The non-transitory computer-readable medium of claim 22, wherein the plurality of instructions cause the processor to generate the plurality of data slices based on at least one integer translation between adjacent data slices, wherein each data slice represents pixels of the light field data belonging to a quantized depth plane.

24. The non-transitory computer-readable medium of claim 22, wherein the plurality of instructions cause the processor to display the three dimensional image using a multi-panel blending techniques comprising mapping the plurality of data slices to a number of data slices equal to a number of display panels and adjusting a color for each pixel based on a depth of each pixel in relation to the plurality of display panels.

25. The non-transitory computer-readable medium of claim 22, wherein displaying the three dimensional image comprises executing a multi-panel blending technique and a multi-panel calibration technique.
